(19) United States
(12) Patent Application Publication
(10) Pub. No.: US 2008/0192670 A1
(43) Pub. Date: Aug. 14, 2008

(54) Repeater device for transmission network

(75) Inventors: Justine Yen, Taipei Hsien (TW); Wen Hsiang Tsai, Taipei Hsien (TW)

Correspondence Address: CHARLES E. BAXLEY, ESQUIRE, 90 JOHN STREET, SUITE 309, NEW YORK, NY, 10038, US

(73) Assignee: Airwise Technology Co., Ltd.

(21) Appl. No.: 11/272,325

(22) Filed: Nov. 9, 2005

(51) Int. Cl. H04B 7/14

(52) U.S. Cl. 370/315

(57) ABSTRACT

A repeater device includes a wireless network receiver device having a low power multi-frequency WLAN telecommunication protocol module for communicating with end users, and a high power multi-frequency WLAN telecommunication protocol module for communicating with wireless networks, a control device includes two servo devices coupled to the low power and the high power multi-frequency WLAN telecommunication protocol modules for controlling the signals of the low power and the high power multi-frequency WLAN telecommunication protocol modules. The control device includes a signal treating device coupled to the servo devices for communicating signals between the servo devices, and a signal regulating device for regulating a transmission power required for the servo devices.

### BACKGROUND OF THE INVENTION

1. Field of the Invention

The present invention relates to a repeater device, and more particularly to a repeater device for allowing the end users to communicate with the wireless networks with a wireless local area network (WLAN) module and at the same time to connect their wireless network access point (AP) with another WLAN module to enhance their original wireless transmission distance.

2. Description of the Prior Art

Various kinds of network systems have become more and more popular and have been widely used nowadays. Heretofore, the computers of the end users are required to be coupled to or communicated with the network systems with or via cable connections. However, the cable connected network systems are inconvenient for both the end users and the network system providers.

Recently, wireless network systems have become more and more popular, and have mostly substituted the cable connected network systems. For entering into or for communicating with the wireless network systems, various kinds of wireless card devices are required to be prepared and coupled to the computers of the end users, and include an antenna device for communicating with the wireless network systems. For example, U.S. Pat. No. 6,681,259 to Limilainen et al. discloses one of the typical methods for coupling a wireless terminal to a data transmission network system and a wireless terminal.

However, the typical wireless card devices for the typical wireless network systems normally comprise a single antenna device that may receive and transmit signals of a particular or predetermined frequency only.

However, a number of different wireless technologies have been provided and used for the typical wireless network systems. For example, at least 802.11a, 802.11b and 802.11g of the institute of electrical and electronic engineers (IEEE), i.e., at least three different wireless IEEE 802.11 standard bands: IEEE 802.11a, IEEE 802.11b and 802.11g have been provided and used for the typical wireless network systems.

For communicating with the wireless network systems of different wireless technologies, the end users have to purchase and prepare two or more kinds of wireless card devices each of which includes an antenna device that may receive and transmit signals of a particular or predetermined frequency only.

The present invention has arisen to mitigate and/or obviate the afore-described disadvantages of the conventional wireless card devices for wireless transmission network systems.

### SUMMARY OF THE INVENTION

The primary objective of the present invention is to provide a repeater device for allowing the end users to communicate with the wireless networks with a WLAN module and at the same time to connect their wireless network access point (AP) with another WLAN module to enhance their original wireless transmission distance.

The other objective of the present invention is to provide a repeater device for allowing the end users to connect with their wireless systems with a WLAN module (IEEE 802.11b/g) and at the same time to connect their wireless server with another WLAN module (IEEE 802.11b/g), in which both wireless modules work in different wireless channels, such that their original wireless transmission distance may be enhanced.

In accordance with one aspect of the invention, there is provided a repeater device comprising a repeater device comprising a wireless network receiver device including a low power multi-frequency WLAN telecommunication protocol module for communicating with end users, and a high power multi-frequency WLAN telecommunication protocol module for communicating with wireless networks, a control device including a first servo device and a second servo device coupled to said low power and said high power multi-frequency WLAN telecommunication protocol modules respectively for controlling signals of said low power and said high power multi-frequency WLAN telecommunication protocol modules respectively, and said control device further includes a signal treating device coupled to said first and said second servo devices for communicating signals between said first and said second servo devices, and a signal regulating device coupled to said first and said second servo devices for regulating a transmission power required for said first and said second servo devices.

The low power and said high power multi-frequency WLAN telecommunication protocol module form into a card device for coupling to various telecommunicating facilities, or may be built within the telecommunicating facilities.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a repeater device in accordance with the present invention;

FIG. 2 is another plan schematic view of the repeater device; and

FIG. 3 is a plan schematic view illustrating the operation of the repeater device.

### DETAILED DESCRIPTION OF THE PREFERRED EMBODIMENT

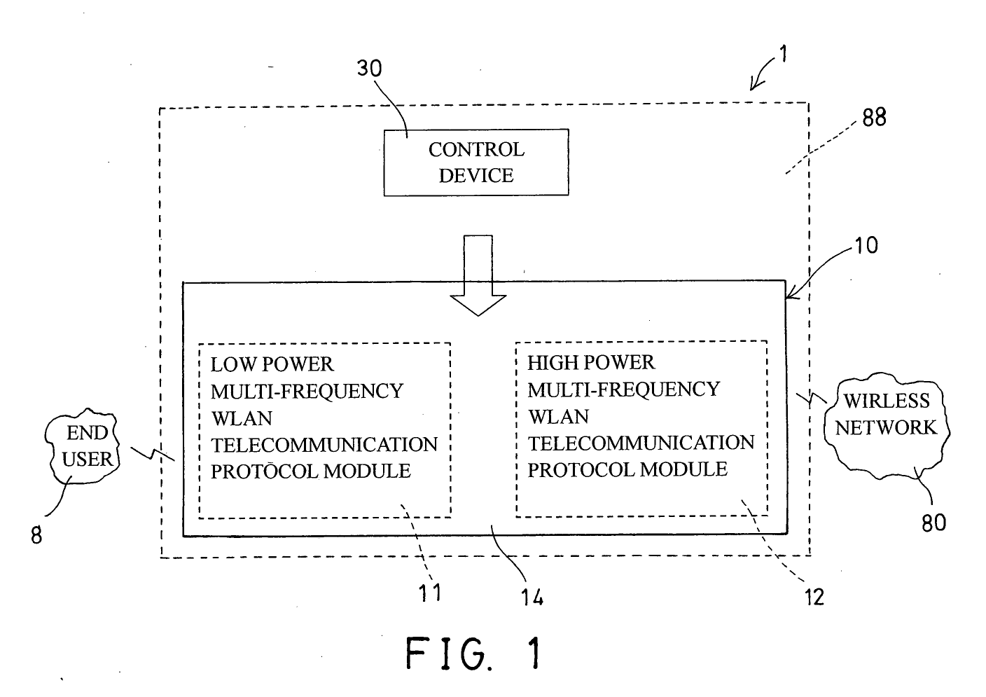

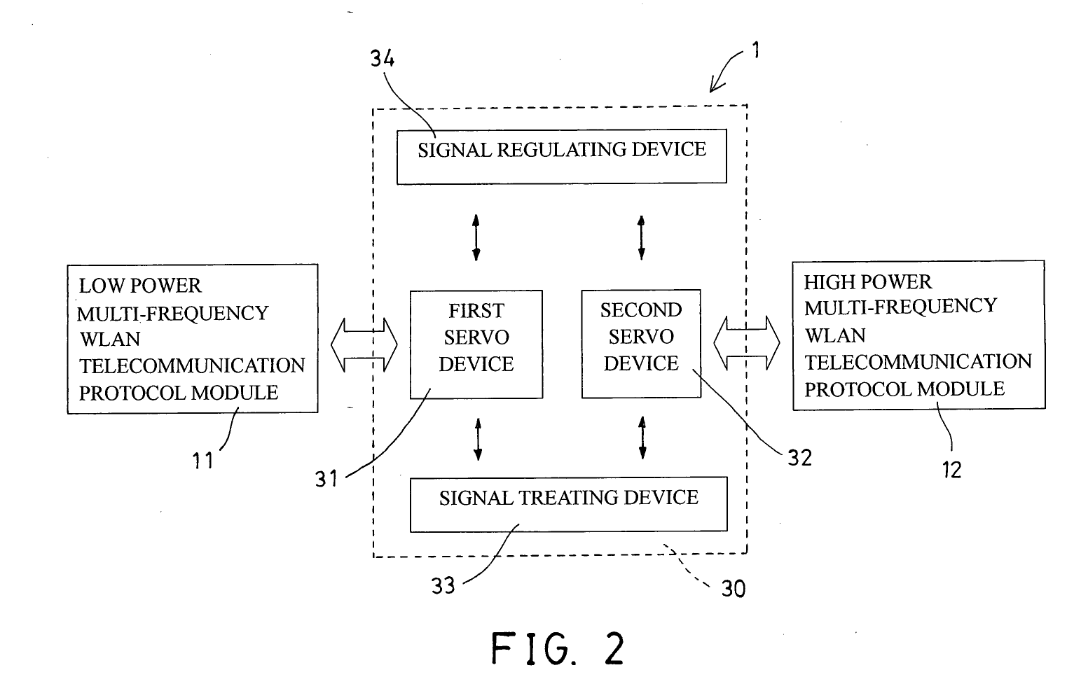

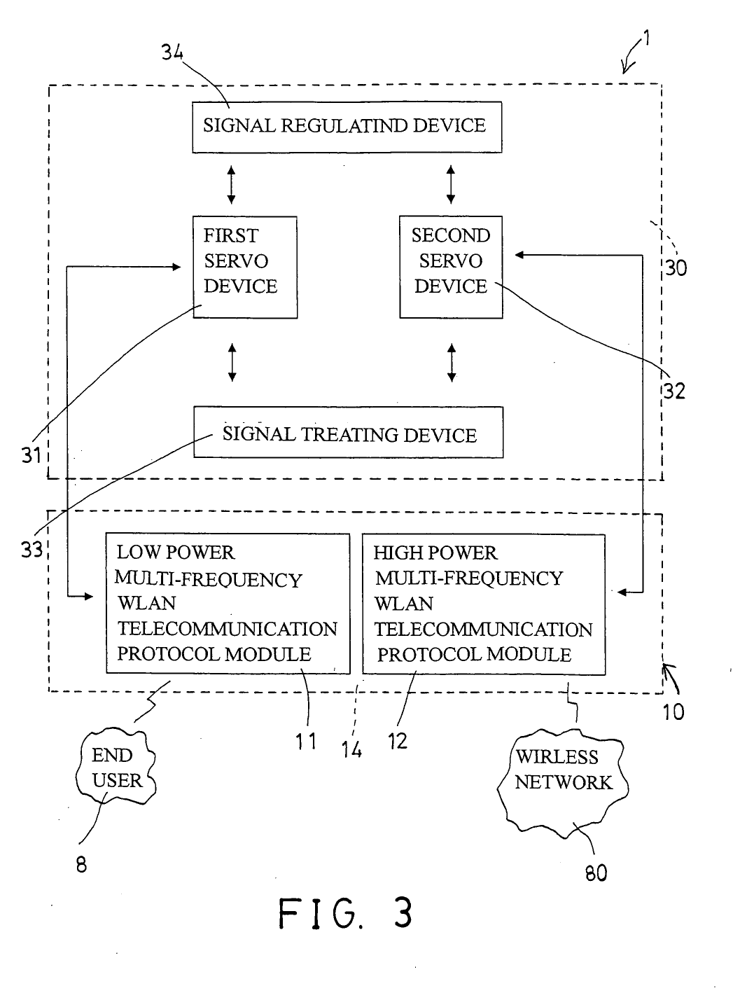

Referring to the drawings, and initially to FIGS. 1 and 2, a repeater device 1 in accordance with the present invention comprises a wireless network receiver device 10 including a low power multi-frequency wireless local area network (WLAN) telecommunication protocol module 11 for telecommunicating with outer end users 8 (FIGS. 1, 3), and a high power multi-frequency wireless local area network (WLAN) telecommunication protocol module 12 for telecommunicating with various wireless networks 80.

It is preferable that the low and the high power multi-frequency wireless local area network (WLAN) telecommunication protocol modules 11, 12 are manufactured or formed into a device 14 or a card member for easily and readily plugging or coupling to various telecommunicating or computer facilities 88 (FIG. 1), or may be manufactured or preformed and built into the telecommunicating or computer facilities 88, for telecommunicating with the end users 8 and various wireless networks 80 respectively.

As shown in FIG. 1, the repeater device 1 further includes a control unit or device 30 coupled to the wireless network receiver device 10 for regulating or repeating or monitoring or treating the signals, such as the package signals received by the low and the high power multi-frequency WLAN telecommunication protocol modules 11, 12. For example, the control device 30 includes a first servo device 31 and a second servo device 32 for coupling to the WLAN telecommunication protocol modules 11, 12 respectively (FIGS. 2, 3), and for treating or controlling the signals of the WLAN telecommunication protocol modules 11, 12.

The control device 30 further includes a signal treating unit or device 33 coupled to the first and the second servo devices 31, 32, for communicating or regulating or negotiating the signals of the WLAN telecommunication protocol modules 11, 12 with each other, and/or for providing frequency band and frequency converting management, dynamic host configuration protocol servers for windows (VDHCP), service set identifiers (SSID), wired equivalency protocol (WEP), etc. to or between the WLAN telecommunication protocol modules 11, 12.

The control device 30 further includes a signal regulating unit or device 34 coupled to the first and the second servo devices 31, 32, for regulating or controlling the transmission power required for the first and the second servo devices 31, 32, for example, and/or arranged for allowing the low power WLAN telecommunication protocol module 11 to receive signals emitted from such as the end users 8 with a lower or decreased transmission power, and thus for allowing the end users 8 to easily communicate with the wireless network receiver device 10 of the repeater device 1.

In operation, as shown in FIG. 3, when the end user 8 sends out the signals, the signals may be received by the low power WLAN telecommunication protocol module 11 of the wireless network receiver device 10, and may then be transmitted through the first servo device 31 and the signal treating device 33 and then to the second servo device 32, and may then be communicated with various wireless networks 80, for allowing the end user 8 to easily communicate with the wireless networks 80 with the VDHCP provided in or by the signal treating device 33, without setting internet protocol (IP) address.

Normally, the VDHCP of the signal treating device 33 will be preset as “on” before communication, and will be changed to “off” after the end user 8 has been successfully communicated with the wireless networks 80. In addition, when the DHCP of the wireless networks 80 is set on “off” status, the end user 8 may obtain the IP address from the signal treating device 33, to allow the end user 8 to easily set and communicated with the wireless networks 80 later, without setting the IP address again and again. Furthermore, the signal treating device 33 may provide the frequency band and frequency converting management, VDHCP, SSID, and/or WEP to or between the first and the second servo devices 31, 32 and thus the WLAN telecommunication protocol modules 11, 12, and to allow the end users to communicate with the wireless networks 80 with a predetermined frequency bandwidth in different frequency bands.

The signal regulating device 34 may be used for regulating the transmitting power for the first and the second servo devices 31, 32 to allow the low power WLAN telecommunication protocol module 11 to send or emit or transmit the signals, with a relatively lowered transmitting power to the end user 8 who may only have a predetermined signal receiving range, and to prevent the end users of the other network systems to send or transmit signals. The high power multi-frequency WLAN telecommunication protocol module 12 may send or emit or transmit the signals with a relatively higher or greater transmitting power to allow the end user 8 to have an increased transmitting distance for the package signals within the WLAN, and to avoid the short of the transmitting distance for the package signals of the other wireless network cards.

It is to be noted that, with the repeater device in accordance with the present invention, the end users may connect their wireless systems with a WLAN module (IEEE 802.11b/g) and at the same time to connect their wireless server with another WLAN module (IEEE 802.11b/g), in which both wireless modules work in different wireless channels, such that their original wireless transmission distance may be enhanced.

In addition, the end users may connect their wireless systems with a WLAN module (IEEE 802.11b/g, 2.4 GHz), and at the same time to connect their wireless server with another WLAN module (IEEE 802.11a) which is based on another IEEE 802.11 standard band and worked with another frequency band (5.8 GHz), in which both wireless modules work in different wireless channels to enhance their original wireless transmission, and to use another frequency band to avoid the undesired interference problem.

Normally, we call the 802.11a, 802.11b, 802.11g as different IEEE 802.11 standard bands, and the frequency band is only for 2.4 GHz, 5.8 GHz. For example, 802.11b and 802.11g work in the frequency band of 2.4 GHz, and 802.11a in 5.8 GHz.

Accordingly, the repeater device in accordance with the present invention may provide the end users to communicate with the wireless networks with a predetermined frequency bandwidth in different frequency bands.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A repeater device comprising:
a wireless network receiver device including a low power multi-frequency WLAN telecommunication protocol module for communicating with end users, and a high power multi-frequency WLAN telecommunication protocol module for communicating with wireless networks,
a control device including a first servo device and a second servo device coupled to said low power and said high power multi-frequency WLAN telecommunication protocol modules respectively for controlling signals of said low power and said high power multi-frequency WLAN telecommunication protocol modules respectively, and
said control device further including a signal treating device coupled to said first and said second servo devices for communicating signals between said first and said second servo devices, and a signal regulating device coupled to said first and said second servo devices for regulating a transmission power required for said first and said second servo devices.

2. The repeater device as claimed in claim 1, wherein said low power and said high power multi-frequency WLAN telecommunication protocol module form into a device for coupling to various telecommunicating facilities.
